(19) United States
(12) Patent Application Publication
(10) Pub. No.: US 2017/0362070 A1
(43) Pub. Date: Dec. 21, 2017

(54) METHOD AND APPARATUS FOR CLOSING RECEPTACLES

(71) Applicant: GEA PROCOMAC S.P.A., 43038 SALA BAGANZA (PARMA) (IT)

(72) Inventor: PAOLO PAGLIARINI, PARMA (IT)

(73) Assignee: GEA PROCOMAC S.P.A., 43038 SALA BAGANZA (PARMA) (IT)

(21) Appl. No.: 15/529,934

(22) PCT Filed: Nov. 27, 2015
(86) PCT No.: PCT/IB2015/059159

§ 371 Date: May 25, 2017

(30) Foreign Application Priority Data
Dec. 1, 2014 (IT) PR2014A000080

(51) Int. Cl. B67B 3/20; B67B 3/26; B67B 5/03

(52) U.S. Cl. CPC B67B 3/20; B67B 5/032; B67B 3/264; B67B 2201/03; B67B 2201/08; B67B 2201/01

(57) ABSTRACT

A method for closing receptacles (2), comprising steps of: in a controlled-contamination environment (6) having a volume that extends into a restricted zone about the neck (2b) of the receptacles, resting and pressing a closure (10) onto a mouth (2a) of each receptacle (2); screwing the capsule (10) onto the neck (2b) of the corresponding receptacle (2) externally of the controlled contamination environment (6).

### TECHNICAL FIELD

The present invention relates to a method and an apparatus for closing receptacles.

The reference sector is the bottling of so-called “sensitive” food products, i.e. products that are particularly sensitive to bacteriological contamination and oxidation, such as, for example, isotonic drinks, juices, nectars, soft drinks, tea, milk-based drinks, coffee-based drinks, etc., for which the prevention of possible microbiological contamination throughout all packaging stages is of fundamental importance.

### BACKGROUND ART

Packaging lines using aseptic technology are already known, wherein the various operations take place in a controlled contamination environment, so that the bottled products can be stored for a prolonged period of time and have chemical/physical and organoleptic stability even at room temperature.

Aside from differences in design, a “conventional” aseptic bottling line includes:
forming the container starting with a parison made of a thermoplastic material;
chemical sterilization of the formed container;
rinsing, filling and capping of the filled container, to be carried out in a sterile environment.

The main drawback of conventional lines is related to the need to have to sterilize the container once it has been formed and to maintain the sterilized state thereof throughout all subsequent operations, for example the filling and capping operations.

A modern concept of an aseptic bottling line instead envisages:
sterilization of the parison using chemical agents or radiations;
“aseptic” forming of the container starting with a sterilised parison;
filling and capping of the filled container, to be carried out in a sterile environment.

In this area the Applicant has developed a completely aseptic blowing machine and a bottling line in which the process zone of each operating unit—from the forming by stretch-blowing to the filling and capping—is protected by a dedicated microbiological isolator, from which the movement and manipulating means of parisons/receptacles are excluded (see European Patent EP2279850).

The main drawback of this solution clearly lies in its considerable structural complexity, in the large volume of the sterile zones (though being restricted and profiled about the operating units) and in the difficulty of maintaining sterile conditions internally of the isolators.

It should also be added that not all the manual procedures required during operation (e.g. removal of obstacles) can be performed with the use of handling gloves: in some cases, it may be necessary to open the isolator access door, resulting in the loss of sterile conditions. Upon completion of the procedure, a sterile environment must be restored, resulting in an evident loss of time due to downtime of the line.

In this context, attention turns to the capping of the receptacles in a non-aseptic line, by means of pressure caps or capsules.

In a known solution, described in document EP2300352, the capping of the receptacles occurs in a sterile environment confined to the neck zone. Document EP0447759 instead relates to a capping using crown caps or metal caps enveloping the mouth, the threading of which is created at the moment of screwing-on.

Before applying the cap on the mouth, steam is dosed into the already-filled container. The steam on cooling creates a depression and thus maintains the cap in position.

### DISCLOSURE OF THE INVENTION

In this context, the technical task underpinning the present invention is to provide a method and an apparatus for closing receptacles, which obviate the drawbacks of the prior art as cited above.

In particular, an object of the present invention is to provide an apparatus for closing receptacles having small dimensions and a simplified structure with respect to the prior art.

A further aim of the present invention is to provide a method and an apparatus for closing receptacles which is easier and more rapid to sterilize.

A further aim of the present invention is to provide a closing method for receptacles in which the sterilization times are shortened and the operations for maintaining the sterility are simplified.

The stated technical task and specified aims are substantially achieved by an elevator door, comprising:
an application unit of closures configured to rest and press onto the mouth of each receptacle a concave closure;
a tightening unit for tightening the closures configured to screw each concave closure to the neck of the corresponding receptacle, the application unit for applying the closures comprising an isolator adapted to define a third controlled contamination environment containing at least the neck of the receptacles.

The controlled-contamination environment preferably has a volume that extends into a restricted zone about the neck of the receptacles.

The controlled contamination environment preferably extends up to containing at least the “bague”, or “finish” of the receptacles, the body of the receptacles remaining external of the controlled contamination environment.

The application unit of the closures preferably comprises a plurality of guides arranged so as to drop the closures from above onto the mouth of the receptacles and at least an inclined plane able to exert pressure on the closures positioned on the mouth of the receptacles.

The tightening unit is preferably a non-aseptic capper.

At least a star conveyor is preferably interposed between the application unit and the tightening unit. The transfer star conveyor bears a plurality of pliers operatively active on the neck of the receptacles for preventing crushing of the receptacles.

The stated technical task and specified aims are substantially attained by a method for closing receptacles comprising steps of:
resting a concave closure on the mouth of each receptacle;
pressing each concave closure onto the mouth of the corresponding receptacle;
screwing each concave closure onto the mouth of the corresponding receptacle.

Advantageously, the step of resting and the step of pressing each concave closure on the mouth of the corresponding receptacle occur in a controlled contamination environment, while the step of screwing each concave closure to the neck of the corresponding receptacle occurs externally of the controlled contamination environment.

The step of resting each concave closure on the mouth of the corresponding receptacle is preferably done by the “a la volée” or “on the fly” gripping method.

The step of pressing each concave closure on the mouth of the corresponding receptacle is preferably done by use of an inclined plane encountered by the receptacle.

### BRIEF DESCRIPTION OF DRAWINGS

Further characteristics and advantages of the present invention will more fully emerge from the non-limiting description of a preferred but not exclusive embodiment of a method and an apparatus for closing receptacles, as illustrated in the accompanying drawings, in which:

FIG. 1 illustrates a production apparatus of receptacles, according to the present invention, in a schematic plan view;

FIGS. 2a-2b respectively illustrate a rest and pressure step and a blocking step of a closure on a receptacle in the closing apparatus of FIG. 1;

FIG. 3 illustrates a concave closure to be applied to a receptacle.

### DETAILED DESCRIPTION OF PREFERRED EMBODIMENTS OF THE INVENTION

With reference to the figures, number 1 denotes a device for closing receptacles 2. In particular the receptacles 2 are made of a thermoplastic material, preferably PET.

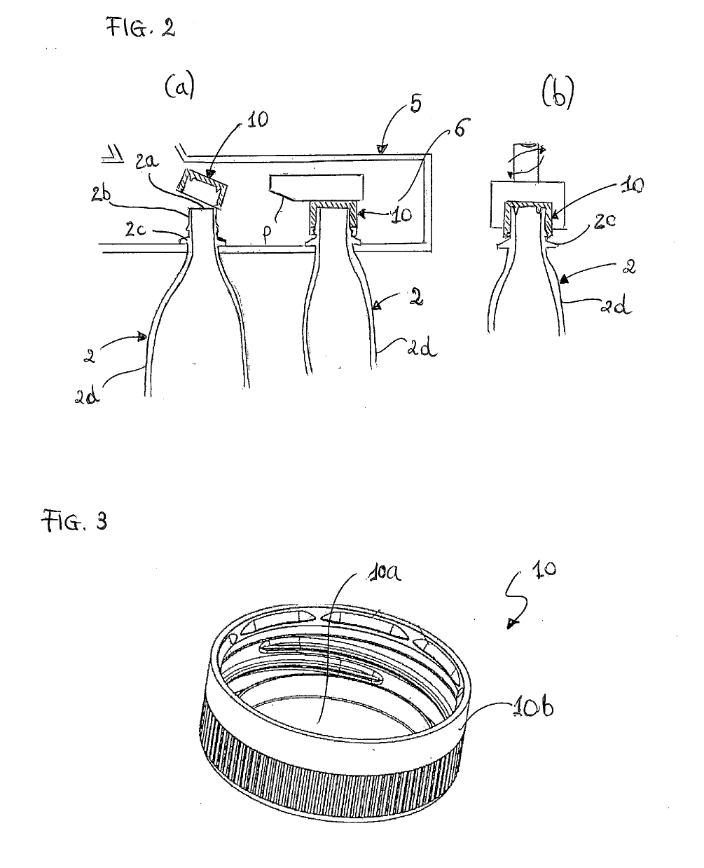

In this context, by concave closure 10 is meant a capsule or a cap comprising a base 10a and a lateral surface 10b which extends from the base 10a and defines therewith a cavity (see FIG. 3). On the opposite side of the base 10a, the closure 10 has an opening destined to accommodate the mouth 2a of a receptacle 2.

In particular, the concave closure 10 has an annular ribbing projecting from the base 10a internally of the cavity and able to engage with the inside of the neck of the receptacle 2 in such a way as to guarantee the hermetic seal.

For example, document WO2009/027227 describes and illustrates a concave closure 10 applicable to the receptacle by means of the method described herein.

The closing apparatus 1 is preferably of the rotating carousel type. Alternatively, the closing apparatus 1 is of a linear type.

The closing apparatus 1 comprises at least two distinct units: an application unit 3 of the concave closures 10 to the receptacles 2 and a tightening unit 4 of the closures 10 already applied on the receptacles 2. In particular, the application unit 3 of the closures 10 is configured for resting and pressing the closures 10 onto the mouth 2a of the receptacles 2.

In the application unit 3 each closure 10 is preferably rested on the mouth 2a of the corresponding receptacle 2 and is then pressed on the mouth 2a. In the present embodiment described and illustrated herein the closure 10 is dropped from above on the mouth 2a of the receptacle 2 by means of guides. In the bottling sector, this is referred-to as “a la volèe”, or “on the fly”. The pressing of the closure 10 on the mouth 2a is done by means of an inclined plane P encountered by the receptacle 2 during movement thereof.

The “on the fly” gripping concept is well known, for example in non-aseptic capping machines and will therefore not be further detailed herein.

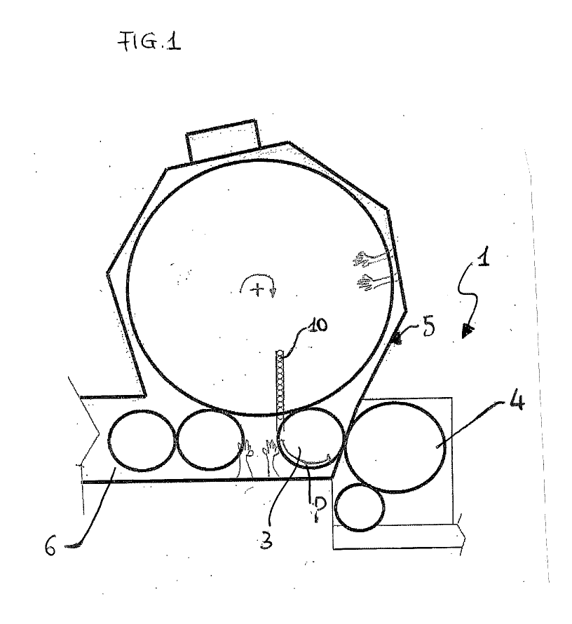

For example, the inclined plane P is the lower plane of a circular sector located above the mouths 2a of the receptacles 2, as illustrated in FIG. 1. The application unit 3 for applying the closures 10 comprises an isolator 5 adapted to define a controlled contamination environment 6 containing at least the neck 2b of the receptacles 2.

The controlled-contamination environment 6 preferably has a volume that extends into a restricted zone about the neck 2b of the receptacles 2.

In particular, the controlled contamination environment 6 extends up to containing at least the “bague” or “finish” 2c of the receptacles 2 while the body 2d of the receptacles is external of the environment 6, as illustrated in FIG. 2a.

In an embodiment, the controlled-contamination environment 6 extends up to containing also a zone just below the finish 2c, so that the majority of the body 2d of the receptacles 2 is external of the environment 6.

In this context, the technical term “bague” or “finish” relates to a circumferential protuberance of the neck 2b of the receptacle 2, located below the threaded zone of the neck 2b.

In the tightening unit 4, each closure 10 is screwed to the neck 2b of the corresponding receptacle 2 in such a way as to seal it and make the seal definitive. For this purpose, the lateral surface 10b of the closure 10 is internally threaded so as to be screwed to the external thread of the neck 2b of the receptacle 2.

The tightening unit 4 preferably consists of a known-type non-aseptic capper.

A receptacle movement system is preferably included between the application unit 3 and the tightening unit 4 of the capsules, so that reciprocal contact between the system and the receptacles is avoided. For example, this movement system comprises at least a star conveyor bearing a plurality of pliers operatively active on the neck 2b of the receptacles 2.

The movement without reciprocal contact has the aim of preventing the crushing of the receptacles 2 which might cause the raising of the closures 10.

The closing method of the receptacles according to the present invention, is described below.

In a first step, illustrated in FIG. 2a, the concave closure 10 is rested on the mouth 2a of the corresponding receptacle 2 gripped “a la volèe” or “on the fly”. The first step takes place in the controlled contamination environment 6.

In a second step, illustrated in FIG. 2a, the concave closure 10 is pressed on the mouth 2a of the corresponding receptacle 2 in such a way as to create a temporary physical barrier to the entry of contaminants into the receptacle 2. For example, such a pressure is exerted by the inclined plane P. This second step also takes place in the controlled contamination environment 6.

In a third step, illustrated in FIG. 2b, the concave closure 10 is screwed on the neck 2b of the corresponding receptacle 2 so as to seal it. The third step takes place after the second step, but externally of the controlled contamination environment 6. In particular, such third step is done using a traditional capper 4, i.e. not aseptic (thus in a non-sterile environment).

The characteristics of the method and closing apparatus of receptacles according to the present invention emerge clearly from the above description, as do the advantages.

In particular, the separation of the rest-closure steps of the closures from the screwing-on step of the capsules enables predisposing a controlled-contamination environment having smaller dimensions with respect to the known solutions. In particular, in the preferred embodiment the isolator only surrounds a restricted zone about the neck of the receptacles located in the application unit of the closures.

The resting and the subsequent pressure of the closures on the mouth of the receptacles in the controlled contamination zone enables preserving the internal sterility, so that the receptacles can be blocked by screwing the closures externally of the zone (i.e. in a non-sterile zone), in the example in a traditional capper (not aseptic)

The pressure therefore has the aim of maintaining the asepsis without having recourse to steam, as occurs in the solution shown in EP0447759. This leads to a reduction in sterile volumes and, consequently, sterilisation times, as well as a reduction in the number of critical components (capping heads, roto-translating members, heat barriers or chemical barriers, bellows, etc.) and a general reduction in costs.

1-9. (canceled)

10. Apparatus (1) for closing receptacles (2), comprising:
an application unit (3) of closures configured to place and press a concave closure (10) onto the mouth (2a) of each receptacle (2), said application unit (3) for applying the closures comprising an isolator (5) adapted to define a controlled contamination environment (6) containing at least the neck (2b) of the receptacles (2);
a non-aseptic capper (4) for tightening the closures configured to screw each concave closure (10) to the neck (2b) of the corresponding receptacle (2) in a non-sterile environment which is external to the controlled contamination environment (6),
characterised in that said controlled contamination environment (6) has a volume that extends into a narrow zone around the neck (2b) of the receptacles (2).

11. Closing apparatus (1) according to claim 10, wherein said controlled contamination environment (6) extends so as to contain at least the bague (2c) of the receptacles (2), the body (2d) of the receptacles (2) being external to said controlled contamination environment (6).

12. Closing apparatus (1) according to claim 10, wherein said application unit (3) for applying the closures comprises a plurality of guides arranged in such a way as to place said closures (10) from on high on the mouth (2a) of the receptacles (2) and at least an inclined plane (P) able to exert pressure onto the closures (10) placed on the mouth (2a) of the receptacles (2).

13. Closing apparatus (1) according to claim 10, comprising at least a transferring star-wheel interposed between said application unit (3) and said non-aseptic capper (4), said transferring star-wheel bearing a plurality of pliers that are operatively active on the mouth (2b) of the receptacles (2) in order to avoid crushing of said receptacles (2).

14. Method for closing receptacles (2) using the closing apparatus (1) according to claim 10, comprising the steps of:
placing a concave closure (10) on the mouth (2a) of each receptacle (2);
pressing each concave closure (10) on the mouth (2a) of the corresponding receptacle (2);
screwing each concave closure (10) to the neck (2b) of the corresponding receptacle (2), characterised in that said step of placing and said step of pressing each concave closure (10) on the mouth (2a) of the corresponding receptacle (2) occur in the controlled contamination environment (6) of said closing apparatus (1), while said step of screwing each concave closure (10) to the neck (2b) of the corresponding receptacle (2) occurs externally to said controlled contamination environment (6).

15. Method according to claim 14, wherein said step of placing each concave closure (10) on the mouth (2a) of the corresponding receptacle (2) is performed “a la volèe”.

16. Method according to claim 14, wherein said step of pressing each concave closure (10) on the mouth (2a) of the corresponding receptacle (2) is obtained by means of an inclined plane (P) met by the receptacle (2).
